(19) United States
(12) Patent Application Publication
(10) Pub. No.: US 2023/0267247 A1
(43) Pub. Date: Aug. 24, 2023

(54) SYSTEMS AND METHODS FOR REMOTE MANAGEMENT OF ASSET AND DIGITAL PROTECTION RELAYS

(71) Applicant: OPERATION TECHNOLOGY, INC., Irvine, CA (US)

(72) Inventors: Tanuj Khandelwal, Irvine, CA (US); Mohammad Zadeh, Irvine, CA (US); Shaikh Sahid Hossain, Irvine, CA (US)

(21) Appl. No.: 18/108,598

(22) Filed: Feb. 11, 2023

Related U.S. Application Data
(60) Provisional application No. 63/309,359, filed on Feb. 11, 2022.

(51) Int. Cl. G06F 30/20

(52) U.S. Cl. CPC G06F 30/20; G06F 2119/02

(57) ABSTRACT

Disclosed are example embodiments of a system for providing remote management of asset and protection relays, including a memory and a processor, coupled to the memory. The processor is configured to execute instructions from the memory causing the processor to addresses data management, personnel training, systems integration, maintenance testing, documentation combined with change management workflows.

### CLAIM OF PRIORITY UNDER 35 U.S.C. § 119

The present Application for Patent claims priority to Provisional Application No. 63/309,359 entitled “SYSTEMS AND METHODS FOR REMOTE MANAGEMENT OF ASSET AND DIGITAL PROTECTION RELAYS,” filed Feb. 11, 2022, and assigned to the assignee hereof and hereby expressly incorporated by reference herein.

### TECHNICAL FIELD

The disclosure relates generally to the field of power systems, specifically and not by way of limitation, some embodiments are related to management of power systems.

### BACKGROUND OF THE INVENTION

Some of the industry challenges and operational issues may include, but are not limited to achieving a single source of truth for engineering and operation, mapping of electrical, physical, thermal characteristics for electrical equipment in transmission and distribution protection system, successful and continuous management of data and assets, a lack of centralized protection relay database information, manual process of relay settings upload and download, a lack of asset information repository, a tedious procedure for protection relay settings change management, different make and model of protection relays and their proprietary software, frequent incidences require root cause analysis to achieve system reliability and stability, a costly process of manual retrieval of disturbance records which requires special manpower to spend a full day, digital twin representation of the actual asset information, integration of asset management system with power system simulation to assist the power engineering to evaluate and optimizing the protection settings, time spent on data collection used for protection and arc flash studies, and/or relay performance under operating conditions and system disturbances.

Consequently, there is a need for systems and methods that may address the above discussed issues.

### SUMMARY

In one example implementation, an embodiment includes a system for providing remote management of asset and protection relays.

Disclosed are example embodiments of a system for providing remote management of asset and protection relays, including a memory and a processor, coupled to the memory. The processor is configured to execute instructions from the memory causing the processor to addresses data management, personnel training, systems integration, maintenance testing, documentation combined with change management workflows.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 is a block diagram illustrating remote management of asset and protection relays in accordance with the systems and methods described herein.

FIG. 2 is a block diagram illustrating a remote management of asset and protection relays workflow in accordance with the systems and methods described herein.

FIG. 3 is a block diagram illustrating a remote management of asset and protection relays architecture in accordance with the systems and methods described herein.

FIG. 4 is a block diagram illustrating a remote management system coupled to a telecommunications network in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

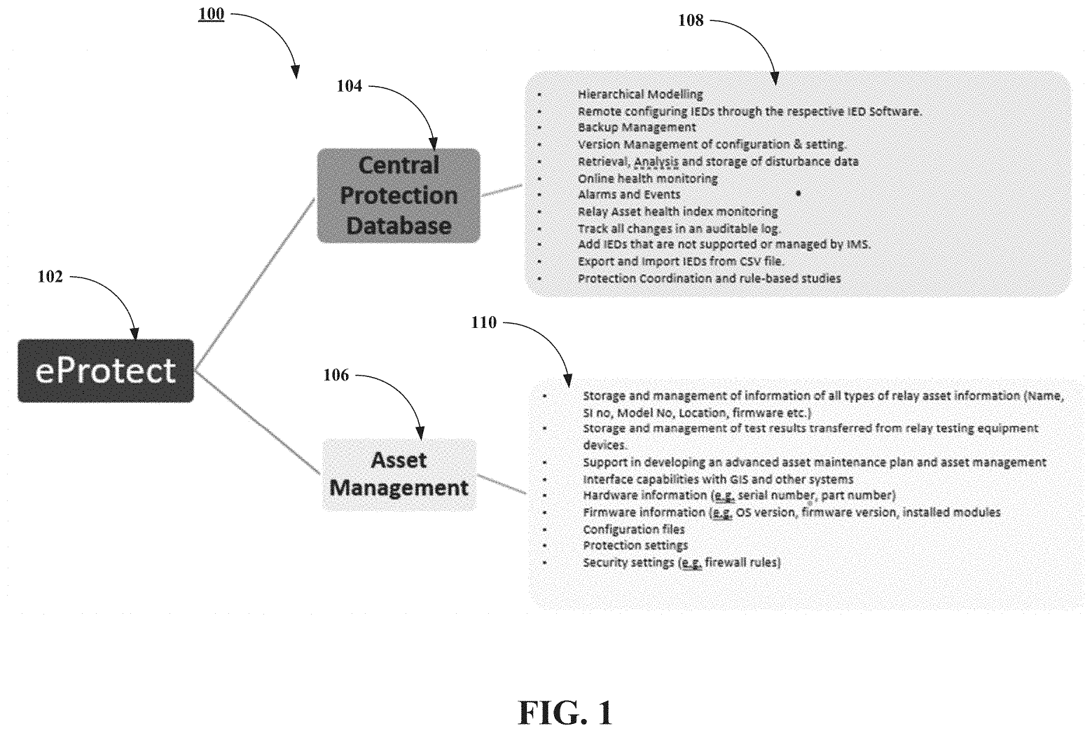

FIG. 1 is a block diagram illustrating remote management of asset and protection relays 100 in accordance with the systems and methods described herein. The remote management of asset and protection relays 100 includes eProtect block 102, central protection database block 104, and asset management block 106. The eProtect block 102 is coupled to the central protection database block 104 and the asset management block 106. The central protection database block 104 may manage one or more of hierarchical modeling, remote configuration IEDs through the respective IED software, backup management, version management of configuration and setting, retrieval, analysis, and storage of disturbance data, online health monitoring, alarms and events, relay asset health index monitoring, track all changes in an auditable log, add IED's that are not supported or managed by IMS, export and import IEDs from CSV file, protection coordination and rule based studies 108. The asset management block 106 may manage one or more of storage and management of information of all types of relay asset information parentheses SI number, model number, location, firmware, etc.), storage and management of test results transferred from relay testing equipment devices, support in developing and advanced asset maintenance plan and asset management, interface capabilities with GIS and other systems, hardware information parentheses e.g., serial number, part number), firmware information (e.g., OS version, firmware version, installed modules, configuration files), protection settings, security settings (e.g., firewall rules) 110.

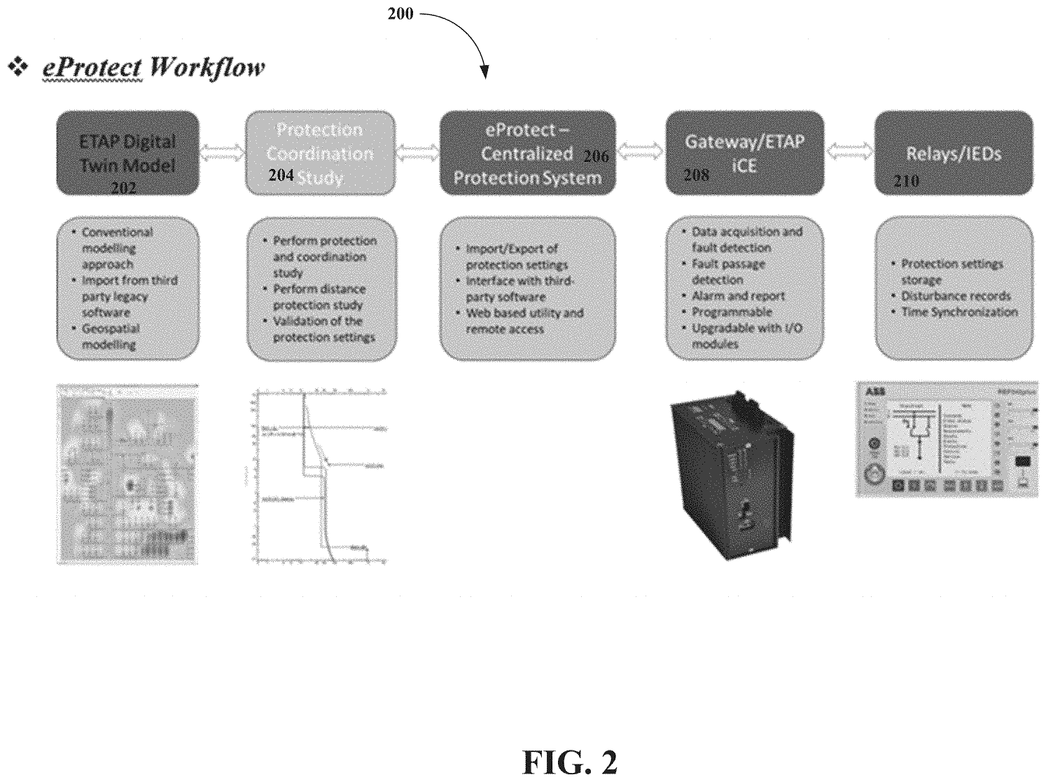

FIG. 2 is a block diagram illustrating a remote management of asset and protection relays workflow 200 in accordance with the systems and methods described herein. The remote management of asset and protection relays workflow 200 includes an ETAP Digital Twin Module 202, a Protection Coordination Study 204, an eProtect Centralized Protection System 206, a Gateway/ETAP iCE 208, and a Relay/IEDs 210. In the illustrated embodiment the ETAP Digital Twin Module 202 is coupled to the Protection Coordination Study 204, which is coupled to the eProtect Centralized Protection System 206. The eProtect Centralized Protection System 206 is coupled to the Gateway/ETAP iCE 208, which is coupled to the Relay/IEDs 210. Accordingly, the ETAP Digital Twin Module 202, the Protection Coordination Study 204, the eProtect Centralized Protection System 206, the Gateway/ETAP iCE 208, and the Relay/IEDs 210 may all be coupled to each other, either directly or through one or more other blocks.

The ETAP Digital Twin Module 202 may manage one or more of conventional modeling approach, import from third party legacy software, and geospatial modeling. The Protection Coordination Study 204 may manage one or more of performing protection and coordination study, performing distance protection study, and validation of the protection settings. The eProtect Centralized Protection System 206 may manage one or more of import slash export of protection settings, interface with third party software, and web-based utility and remote access. The Gateway/ETAP iCE 208 may manage one or more of data acquisition and fault detection, fault passage detection, alarming and reporting. The Gateway/ETAP iCE 208 may be programmable, and upgradable, e.g., using I/O modules. The Relay/IEDs 210 protection settings storage, disturbance records, and time synchronization.

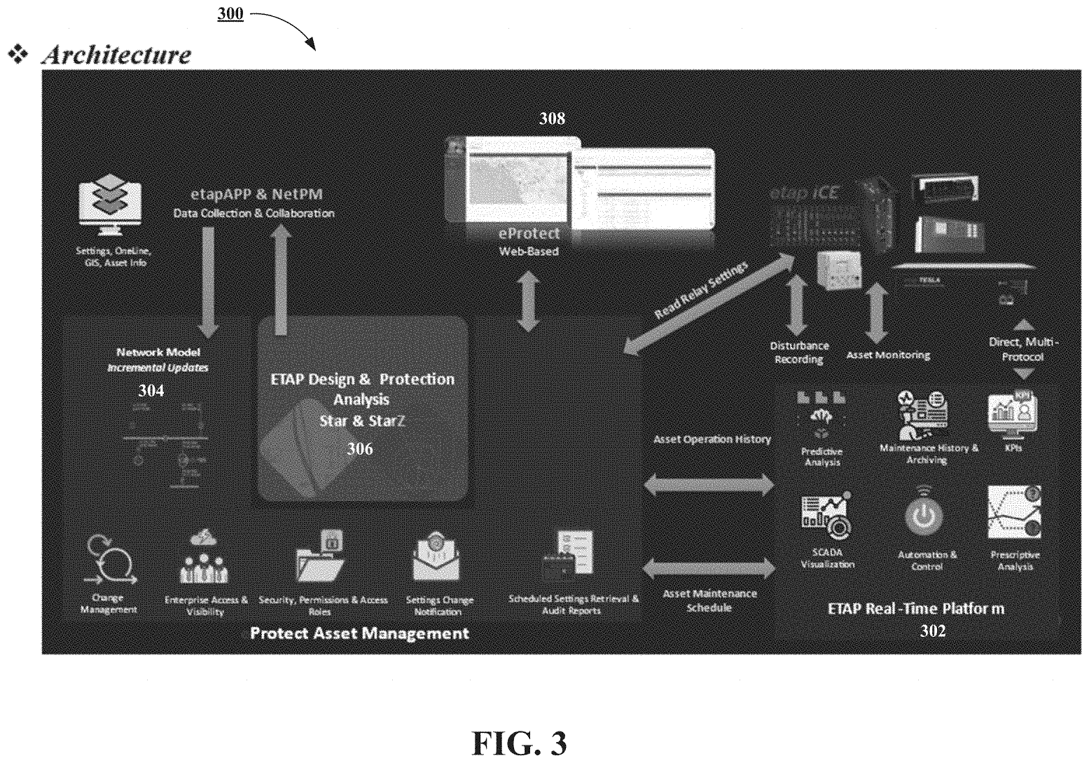

FIG. 3 is a block diagram illustrating a remote management of asset and protection relays architecture 300 in accordance with the systems and methods described herein. The example architecture includes an ETAP real-time platform 302, a network model 304, and an ETAP design and protection analysis block 306. One or more aspects may be web-based 308.

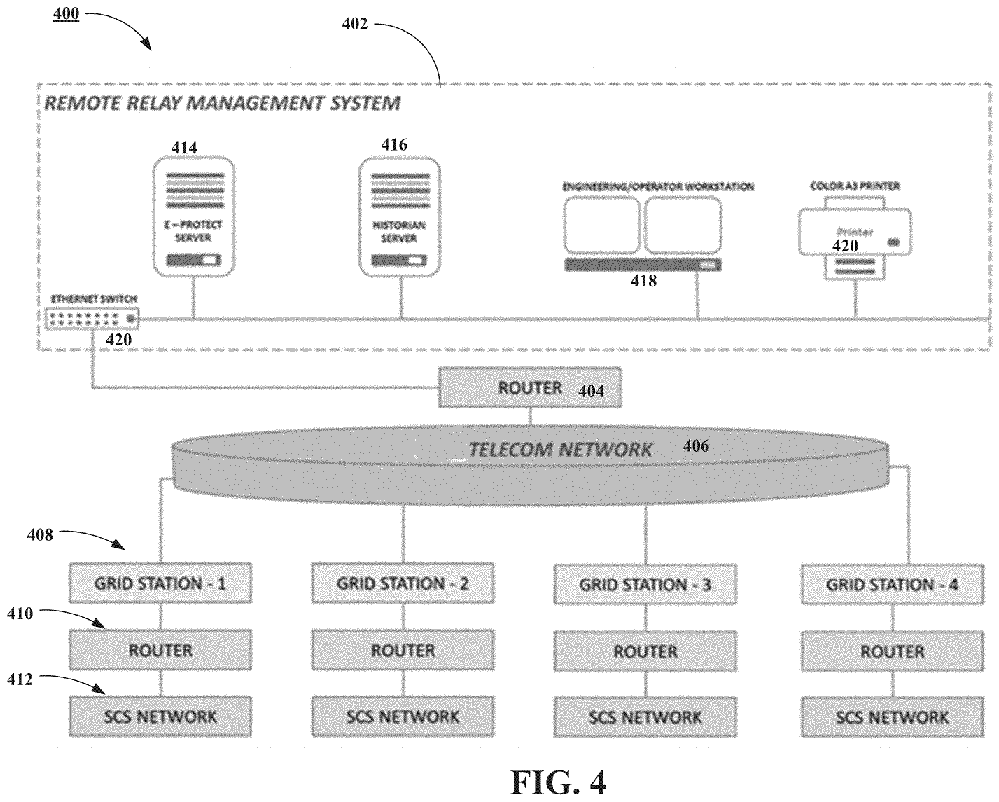

FIG. 4 is a block diagram illustrating a remote management system coupled to a telecommunications network 400 in accordance with the systems and methods described herein. The remote management system coupled to a telecommunications network 400 may include a remote relay management system 402, a router 404, and a telecommunications communications network 406 coupled to a one or more grid stations 408, routers 410, and SCS networks 412. The remote relay management system 402 may include and E-protect server 414, a historian server 416, an engineering/operator workstation 418, and a printer 420, e.g., a color printer. Each of these may be coupled to the router 404 through an Ethernet switch 422.

As discussed above, some of the industry challenges and operational issues may include, but are not limited to achieving a single source of truth for engineering and operation, mapping of electrical, physical, thermal characteristics for electrical equipment in transmission and distribution protection system, successful and continuous management of data and assets, a lack of centralized protection relay database information, manual process of relay settings upload and download, a lack of asset information repository, a tedious procedure for protection relay settings change management, different make and model of protection relays and their proprietary software, frequent incidences require root cause analysis to achieve system reliability and stability, a costly process of manual retrieval of disturbance records which requires special manpower to spend a full day, digital twin representation of the actual asset information, integration of asset management system with power system simulation to assist the power engineering to evaluate and optimizing the protection settings, time spent on data collection used for protection and arc flash studies, and/or relay performance under operating conditions and system disturbances.

In an example embodiment, a solution may includer a remote management of asset and protection relays (eProtect™). In one example embodiment, power system asset management requires orchestration that addresses data management, personnel training, systems integration, maintenance testing, documentation combined with change management workflows. The systems and methods described herein (e.g., including ETAP eProtect™) may include a centralized enterprise protection asset management solution that communicates with field protection relays and ETAP Protection & Coordination modules to manage location, information, and settings throughout the lifecycle of protective relays and electrical assets.

The systems and methods described herein (e.g., including ETAP “eProtect —Protection Asset Management System”) may include a solution for remote management of protection relays may provide one or more of the following functionalities: eProtect Relay Explorer, Relay health index and real time monitoring status, COMTRADE file download, Waveform capture and Visualization, Disturbance data handling and viewer, Remote configuration of IEDs, Relay setting change management and history, Alarms and events, Trending, Geospatial web visualization of IEDs and substations with exact location, Advance Fault Analysis, Fault Management Application, Thermal imaging, and/or AR & VR through camera.

An example embodiment may include Integrated Power System Analysis, Protection Coordination Analysis. The Integrated Power System Analysis, Protection Coordination Analysis may include Star Auto-Evaluation: Automated Protection Coordination Analysis, and/or Star-Z: Distance Protection.

An example embodiment may include an Advanced Fault Analysis System (AFAS). The AFAS may include one or more of distance of the fault on transmission line, fault severity, and/or fault location on GIS map

An example embodiment may be integration with system including Geospatial Information System (GIS), eSCADA, and/or other systems.

Some example embodiments may include one or more of the following benefits: relay digital twin model, relay setting change management, relay settings tracking dashboard & notification, protection visualization and evaluation, health monitoring and maintenance, integrated with Advanced Fault Analysis System, Automatically import the Protection Device settings, download settings via FTP/SFTP/IEC 61850, upload settings to protection relays remotely, web interface accessible via mobile devices, data collection via etapAPP, compare As-Found to As-Designed settings, Auditing of studies and implementation, Automatic notification of setting changes, make data commonly available from all sites to users, GIS Integration Capability, NERC compliance reporting, Protection system maintenance plan, and/or Allow relay information to be kept in a central location.

The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for providing remote management of asset and protection relays, comprising:
a memory; and
a processor, coupled to the memory, the processor configured to execute instructions from the memory causing the processor to addresses data management, personnel training, systems integration, maintenance testing, documentation combined with change management workflows.

2. The system of claim 1, wherein the processor is further configured to communicate with one or more of a field protection relay and a protection and coordination module.

3. The system of claim 2, wherein the one or more of the field protection relay and the protection and coordination module are configured to manage location, information, and settings throughout the lifecycle of protective relays and electrical assets.

4. The system of claim 1, wherein the processor is further configured to relay health index and real time monitoring status.

5. The system of claim 1, wherein the processor is further configured to perform a Common format for Transient Data Exchange for power systems (COMTRADE) file download.

6. The system of claim 1, wherein the processor is further configured to perform waveform capture and visualization.

7. The system of claim 1, wherein the processor is further configured to perform disturbance data handling and provide a viewer.

8. The system of claim 1, wherein the processor is further configured to perform remote configuration of IEDs.

9. The system of claim 1, wherein the processor is further configured to relay setting change management and history.

10. The system of claim 1, wherein the processor is further configured to provide for alarms and events for remote management of asset and protection relays.

11. The system of claim 1, wherein the processor is further configured to track trending for remote management of asset and protection relays.

12. The system of claim 1, wherein the processor is further configured to provide geospatial web visualization of IEDs and substations with exact location.

13. The system of claim 1, wherein the processor is further configured to fault analysis for remote management of asset and protection relays.

14. The system of claim 13, wherein fault analysis includes advanced fault analysis (AFAS) including one or more of distance of the fault on transmission line, an indicator of fault severity, and fault location.

15. The system of claim 1, wherein the processor is further configured to provide fault management application for remote management of asset and protection relays.

16. The system of claim 1, wherein the processor is further configured to control thermal imaging for remote management of asset and protection relays.

17. The system of claim 1, further comprising a camera, wherein the processor is further configured to control AR and VR through the camera.

18. The system of claim 1, further comprising integrated power system analysis.

19. The system of claim 1, further comprising a Geospatial Information System (GIS).

20. The system of claim 1, further comprising eSCADA.
